(19) United States
(12) Patent Application Publication
(10) Pub. No.: US 2013/0235924 A1
(43) Pub. Date: Sep. 12, 2013

(54) ELECTRONIC APPARATUS AND METHOD FOR ENCODING

(71) Applicant: SAMSUNG ELECTRONICS CO., LTD., Suwon-si (KR)

(72) Inventors: Sung-kyu JANG, Yongin-si (KR); Tae-hee KIM, Seoul (KR); Jum-han BAE, Seongnam-si (KR); Kyung-hwan CHO, Incheon (KR)

(73) Assignee: SAMSUNG ELECTRONICS CO., LTD., Suwon-si (KR)

(21) Appl. No.: 13/760,873

(22) Filed: Feb. 6, 2013

(30) Foreign Application Priority Data
Mar. 6, 2012 (KR) 10-2012-0023007

(51) Int. Cl. H04N 7/26

(52) U.S. Cl. CPC H04N 19/00945
USPC 375/240.01

(57) ABSTRACT

An electronic apparatus is provided, which includes an inputter, which receives a plurality of successive images, and alternately divides the plurality of successive images into a plurality of divided groups according to an order of input, and a plurality of codec units which sequentially intra-encodes the respective successive images of one group, among the plurality of divided groups, and sequentially inter-encodes the respective successive images of another group, among the plurality of divided groups by using the intra-encoded images.

### CROSS-REFERENCE TO RELATED APPLICATIONS

This application claims priority from Korean Patent Application No. 10-2012-0023007, filed on Mar. 6, 2012, in the Korean Intellectual Property Office, the disclosure of which is incorporated herein by reference in its entirety.

### BACKGROUND

1. Field

Apparatuses and methods consistent with exemplary embodiments relate to electronic apparatus and method for encoding. More particularly, exemplary embodiments relate to an electronic apparatus and a method for encoding which are capable of encoding video with high speed.

2. Description of the Related Art

Video data generally has very large data volume. However, it is possible to compress the video data without greatly compromising image quality, by utilizing a relationship between constructed video frames of the video. Video compression may generally include H.263 for use in screen meeting, MPEG-1 of VCD image quality, or MPEG-2 of DVD quality. More recently, MPEG-4 and H.264 have been widespread.

With respect to H.264 video codec, this consists of IDR frame, which can be processed independently, P frame, which can be encoded with reference to previous frames and B frame, which can be encoded with reference to both the previous and following frames.

As the above suggests, a related art video codec requires relatively high resources for encoding because it is necessary to store the results of the previous image in order to continue encoding for the next frames.

Furthermore, as the size of the video image has been increased (e.g., Full HD, UHD) when it comes to the video codec constructed on hardware, the reconstructed images are not stored on the internal local buffer, but stored on the main memory (e.g., DDR memory) of the system.

However, since the system has limited memory bandwidth (i.e., sum of data which can be read and written per second in DDR memory) to use for video compression, there is a need for at least two times of frame reading and one time of frame writing even when one image is referred for the processing of one inter frame.

### SUMMARY

According to aspects of one or more exemplary embodiments, an electronic apparatus and a method for encoding is provided, which is capable of encoding video image with high speed.

According to aspects of an exemplary embodiment, an electronic apparatus may include an inputter, which receives a plurality of successive images, and alternately divides the plurality of successive images into a plurality of divided groups according to an order of input, and a plurality of codec units, which sequentially intra-encodes the respective successive images of one group, among the plurality of divided groups, and sequentially inter-encodes the respective successive images of another group, among the plurality of divided groups, by using the intra-encoded images.

The input unit may alternately divide the plurality of sucessive images into a first group and a second group according to the order of input, and the plurality of codec units may include a first codec unit, which sequentially intra-encodes the respective successive images of the first group, and a second codec unit, which sequentially inter-encodes the respective successive images of the second group by using the respective successive images encoded at the first codec unit.

The first codec unit may decode the encoded images of the first group to generate reconstructed images of the first group, and the second codec unit may inter-encode the images of the second group by using the generated reconstructed images of the first group.

The first codec unit may directly transmit the generated reconstructed images of the first group to the second codec unit.

The second codec unit may decode the images encoded at the first codec unit to generate reconstructed images of the first group, and inter-encode the images of the second group by using the generated reconstructed images of the first group.

The input unit may divide the plurality of successive images into a first group, a second group, and a third group according to the order of input, and the plurality of codec units may include a first codec unit, which sequentially intra-encodes the respective successive images of the first group, a second codec unit, which sequentially inter-encodes the respective successive images of the second group by using the respective images successively encoded at the first codec unit, and a third codec unit, which inter-encodes the respective successive images of the third group by using at least one encoded image of the images of the first group, encoded at the first codec unit, and the images of the second group, encoded at the second codec unit.

The first codec unit may decode the encoded images of the first group to generate reconstructed images of the first group.

The second codec unit may inter-encode the images of the second group by using the generated reconstructed images of the first group.

The third codec unit may inter-encode the images of the third group by using the generated reconstructed images of the first group.

The second codec unit may decode the encoded images of the second group to generate reconstructed images of the second group.

The third codec unit may inter-encode the images of the third group by using the generated reconstructed images of the second group.

The first codec unit may directly transmit the generated reconstructed images of the first group to at least one of the second codec unit and the third codec unit.

The second codec unit may decode the encoded images at the first codec unit to generate reconstructed images of the first group, and inter-encodes the images of the second group by using the generated reconstructed images of the first group.

The third codec unit may decode at least one of the encoded images of the first group, encoded at the first codec unit and the encoded images of the second group, encoded at the second codec unit to generate at least one reconstructed image, and inter-encode the images of the third group by using the generated at least one reconstructed image.

The plurality of codec units may operate in parallel.

The intra-encoding may include at least one compression type of lossless compression, near lossless compression, JPEG, JPEG-XR, H.264, and H.265 compressions.

In one embodiment, a method for encoding an electronic apparatus having a plurality of codec units may include receiving a plurality of successive images, alternately dividing the plurality of successive images into a plurality of divided groups according to an order of input, sequentially intra-encoding, using at least one of the plurality of codec units, the respective successive images of one group, among the plurality of divided groups, and sequentially inter-encoding, using another code unit of the plurality of codec units, the respective successive images of another group of the plurality of divided groups, by using the intra-encoded images.

The method for encoding may additionally include decoding the intra-encoded images to generate reconstructed images, wherein the inter-encoding may include inter-encoding the images of the another group by using the generated reconstructed images.

The intra-encoding and the inter-encoding may be performed in parallel.

The intra-encoding may include at least one compression method of lossless compression, near lossless compression, JPEG, JPEG-XR, H.264, and H.265 compressions.

In one embodiment, an electronic apparatus may include a first image inputter, which receives a first group of even images, among a plurality of images, a second image inputter, which receives a second group of odd images, among the plurality of images, a first codec unit, which successively intra-encodes the first group of even images, and a second codec unit, which successively inter-encodes the second group of odd images using the encoded images of the first codec unit.

### BRIEF DESCRIPTION OF THE DRAWINGS

The above and/or other aspects will be more apparent by describing certain exemplary embodiments with reference to the accompanying drawings, in which:

FIG. 1 is a block diagram of an electronic apparatus according to an exemplary embodiment;

FIG. 2 is a view provided to explain a structure of a plurality of codec units according to a first exemplary embodiment;

FIG. 3 is a view provided to explain a structure of a plurality of codec units according to a second exemplary embodiment;

FIG. 4 is a view provided to explain an operation of a plurality of codec units according to first and second exemplary embodiments;

FIG. 5 is a view provided to explain an operation of a plurality of codec units according to a third exemplary embodiment;

FIG. 6 is a view provided to explain an operation of a plurality of codec units according to a fourth exemplary embodiment;

FIG. 7 is a view provided to explain an operation of a plurality of codec units according to a fifth embodiment;

FIG. 8 is a view provided to explain an operation of a plurality of codec units according to third to fifth exemplary embodiments;

FIG. 9 is a view provided to explain an operation of a plurality of codec units according to a sixth exemplary embodiment;

FIG. 10 is a view provided to explain an operation of a plurality of codec units according to a seventh exemplary embodiment;

FIG. 11 is a view provided to explain an operation of a plurality of codec units according to an eighth exemplary embodiment;

FIG. 12 is a view provided to explain an operation of a plurality of codec units according to sixth to eighth exemplary embodiments;

FIG. 13 is a view provided to explain an operation of a plurality of codec units according to an ninth exemplary embodiment;

FIG. 14 is a view provided to explain an operation of a plurality of codec units according to a tenth embodiment;

FIG. 15 is a view provided to explain an operation of a plurality of codec units according to an eleventh exemplary embodiment;

FIG. 16 is a view provided to explain an operation of a plurality of codec units according to ninth to eleventh exemplary embodiments; and

FIG. 17 is a flowchart provided to explain a method for encoding according to an exemplary embodiment.

### DETAILED DESCRIPTION OF EXEMPLARY EMBODIMENTS

Certain exemplary embodiments will now be described in greater detail with reference to the accompanying drawings.

In the following description, same drawing reference numerals are used for the same elements, even if the reference numerals are in different drawings. The matters defined in the description, i.e., detailed construction and elements, are provided to assist in a comprehensive understanding of the exemplary embodiments. Accordingly, it is apparent that the exemplary embodiments can be carried out without those specifically defined matters. Also, well-known functions or constructions are not described in detail since they would obscure the exemplary embodiments with unnecessary detail.

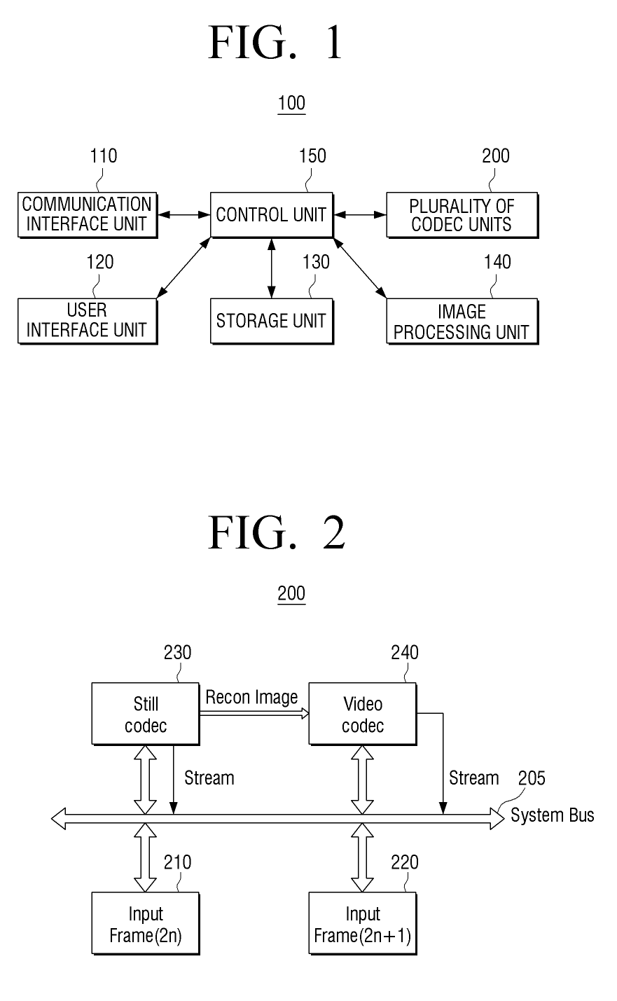

FIG. 1 is a block diagram of an electronic apparatus according to an exemplary embodiment.

Referring to FIG. 1, the electronic apparatus 100 according to an exemplary embodiment may include a communication interface unit 110, a user interface unit 120, a storage unit 130, an image processing unit 140, a control unit 150, and a plurality of codec units 200. The electronic apparatus 100 according to an exemplary embodiment may be implemented as a photographing device, i.e., digital camera, a camcorder, a mobile phone, a webcam, or a black box, which are capable of photographing a plurality of images sequentially, or a PC, a laptop computer, or a portable media player (PMP).

The communication interface unit 110 may be connected to at least one external device (not illustrated), or connected wirelessly through local area network (LAN) and the Internet, or in a wired manner, or connected via universal serial bus (USB) port, Bluetooth module, etc.

The communication interface unit 110 may receive a plurality of images from an external device. The communication interface unit 110 may transmit the video image generated at the plurality of codec units 200 to an external device. The communication interface unit 110 may also receive video content from an external device.

The user interface unit 120 may include a plurality of function keys with which a user can set or select a variety of functions supported by the electronic apparatus 100, and may display various information provided by the electronic apparatus 100. The user interface unit 120 may be implemented in a form such as touchpad through which both input and output are possible, or implemented in a form combining an input device, i.e., a plurality of buttons and a display apparatus, i.e., LCD monitor or OLED monitor.

A user may select through the user interface unit 120 a plurality of images to perform encoding. The user may also select a video image to be played back through the user interface unit 120. The user interface unit 120 may display a decoded image on the plurality of codec units 200.

Settings related to encoding may be input to the user interface unit 120. To be specific, the user may input settings related to the resolution or frame rate of the video to be generated. Meanwhile, the settings may be set to a default setting.

The storage unit 130 may store a plurality of images. The storage unit 130 may store the image processed at the image processing unit 140. The storage unit 130 may either store the video generated at the plurality of codec units 200, or store the video received from an external device.

The storage unit 130 may be implemented as a storage medium provided inside the electronic apparatus 100, or as an external storage medium, i.e., a removable disk including USB memory, or flash memory, a storage medium connected to a photographing device, or a web server connected via network.

The image processing unit 140 may perform compensation operation with respect to a plurality of images. To be specific, the image processing unit 140 may perform format conversion with respect to the plurality of images to be converted into video or digital zoom to adjust image scale, or image processing, i.e., auto white balance (AWB), auto focus (AF), or auto exposure (AE).

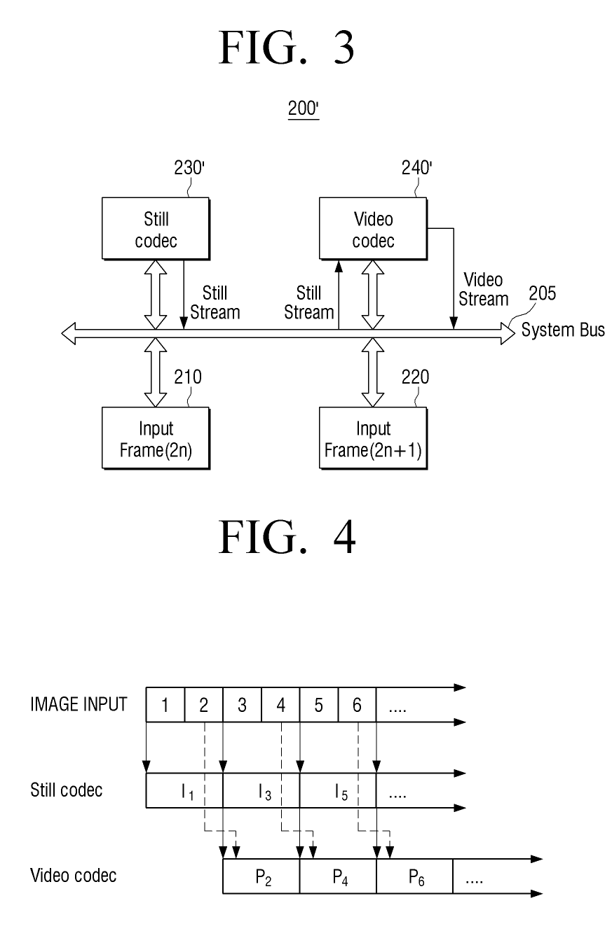

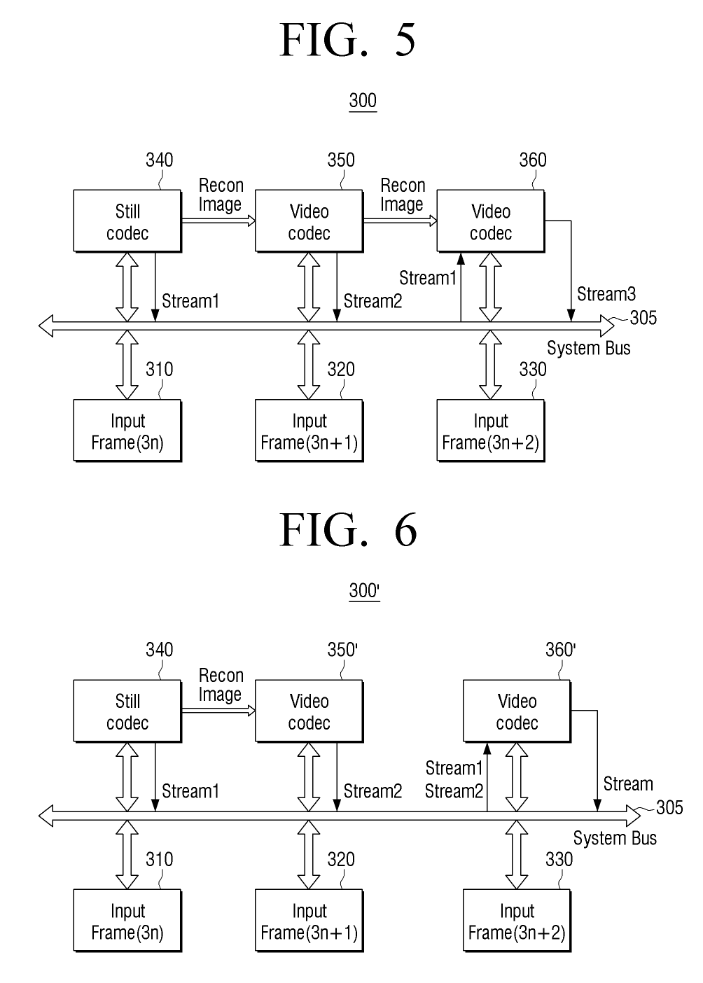

The plurality of codec units 200 may receive a plurality of successive images, and alternately divide the received images into a plurality of groups according to the order of input. To be specific, the plurality of codec units 200 may divide the plurality of images into groups corresponding in number to the codec units 200 of the electronic apparatus 100. As an example, there may be two groups, i.e., exemplary embodiments illustrated in FIGS. 2 and 3, or three groups, i.e., exemplary embodiments illustrated in FIGS. 5 to 15.

The plurality of codec units 200 may sequentially intra-encode successive images of one of the plurality of groups divided by at least one codec unit. The “intra-encode” herein refers to the process of generating frames (e.g., I frames) which can be independently decoded without having to refer to previous or following frames. Intra-encode may be applied as lossless compression, near lossless compression, JPEG, JPEG-XR, H.264, or H.265 compression.

The plurality of codec units 200 may sequentially inter-encode respective successive images of the rest of the plurality of groups divided by at least one codec unit. The “inter-encode” herein refers to the encoding process which refers to previous and/or following frames. Inter-encode may be applied as a variety of conventional compression methods of the image codec.

Meanwhile, although receiving a voice signal is not specifically explained in the present exemplary embodiment, the plurality of codec units 200 may use a separate voice codec unit to generate a video file encoding a voice signal, and a plurality of images using internal microphone, external microphone, or previously stored voice data.

Further, although an example where the plurality of codec units 200 perform encoding is explained above, the plurality of codec units 200 may perform decoding. Since decoding technique corresponds to encoding technique, the encoding operation of the plurality of codec units 200 will be explained with reference to FIGS. 2 to 16.

The control unit 150 may control the respective components inside the electronic apparatus 100. To be specific, in response to an encoding command input, the control unit 150 may control the plurality of codec units 200 to generate a video corresponding to a plurality of images, and control the storage unit 130 to store the generated video. Further, in response to a playback command input with respect to the generated video, the control unit 150 may control the plurality of codec units 200 to perform decoding of a corresponding video, and control the user interface unit 120 to display the decoded video.

Since the electronic apparatus 100 according to an exemplary embodiment generates video using a plurality of codec units, the electronic apparatus 100 may generate the video more rapidly.

Meanwhile, while explaining an exemplary embodiment with reference to FIG. 1, although the plurality of codec units 200 perform the encoding, the plurality of codec units 200 may perform the decoding of the generated video.

FIG. 2 is a view provided to explain the structure of the plurality of codec units according to a first exemplary embodiment.

Referring to FIG. 2, the plurality of codec units 200 may include input units 210, 220, a first codec unit 230 and a second codec unit 240. The first and second codec units 230, 240 may preferably be implemented as hardware.

The input units 210, 220 may alternately divide first and second groups 2n, 2n+1 according to the order the plurality of images are inputted in succession. In the first exemplary embodiment where the two codec units are implemented, the input units 210, 220 may include the first input unit 210 and the second input unit 220.

The first input unit 210 may provide the first codec unit 230 with an image corresponding to the first group 2n, among the plurality of images.

The second input unit 220 may provide the second codec unit 240 with an image corresponding to the second group 2n+1, among the plurality of images.

The first codec unit 230 may successively intra-encode the successive images of the first group 2n. By referring to FIG. 4, the first codec unit 230 may receive the first image 1 from the first input unit 210 and intra-encode the first image 1, generate an encoded image I1 (to be specific, intra frame) of the first image 1. At this time, the image (stream) of the first group 2n encoded at the first codec unit 230 may be stored at the storage unit 130 through the system bus 205 of the electronic apparatus 100. The “intra frame” herein refers to a video frame which is generated by intra encoding.

The first codec unit 230 may decode the encoded image of the first group 2n to generate reconstructed image of the first group 2n, and may directly transfer the generated reconstructed image of the first group 2n to the second codec unit 240 without using the system bus 205. In one exemplary embodiment, since the reconstructed image is transferred directly to the second codec unit 240, system bus resources can be saved. In actual implementation, however, the reconstructed image may also be transferred to the second codec unit 240 via the system bus 205.

The second codec unit 240 may inter-encode the successive images of the second group 2n+1 by using the respective images, which are sequentially encoded at the first codec unit 230. To be specific, the second codec unit 240 may sequentially inter-encode the respective successive images of the second group 2n+1, by using the respective reconstructed images of the first group 2n, directly transferred from the first codec unit 230. By referring to FIG. 4, the second codec unit 240 may receive a reconstructed image 1′ of the first image 1 from the first codec unit 230, receive the second image 2 from the second input unit 220, and inter-encode the second image 2 by using the reconstructed image 1′ of the first image 1. Thereby, an encoding image P2 is generated (to be specific, inter-frame) corresponding to the second image 2. The image (stream) of the second group 2n+1, encoded at the second codec unit 240, may be stored at the storage unit 130 via the system bus 205 of the electronic apparatus 100. The “inter-frame” refers to the video frame generated by the inter-encoding.

FIG. 3 is a view provided to explain the structure of a plurality of codec units according to a second exemplary embodiment.

To be specific, in the second exemplary embodiment, the first codec unit 230′ does not generate a reconstructed image which is different from the first exemplary embodiment.

Referring to FIG. 3, the plurality of codec units 200′ may include input units 210, 220, and first and second codec units 230′, 240′. The second codec unit 240′ may be implemented as hardware. The first codec unit 230′ may be implemented as hardware, or alternatively, implemented as software which can operate on a CPU or a digital signal processor (DSP).

Since the operation of the input units 210, 220 are identical to the operation explained above with reference to FIG. 2, repetitive explanation thereof will be omitted.

The first codec unit 230′ may sequentially intra-encode the respective successive images of the first group 2n. By referring to FIG. 4, the first codec unit 230′ may receive the first image 1 from the first input unit 210, and intra-encode the first image 1 to generate an intra-frame I1 with respect to the first image 1.

The second codec unit 240′ may sequentially inter-encode the respective successive images of the second group 2n+1 by using the respective images, which are successively encoded at the first codec unit 230′. To be specific, the second codec unit 240′ may receive the images of the first group 2n, encoded at the first codec unit 230′, and receive the images of the second group 2n+1, from the second input unit 220. The second codec unit 240′ may then decode the images of the first group 2n which are encoded at the first codec unit 230′ to generate reconstructed images of the first group 2n, and sequentially inter-encode the successive images of the second group 2n+1, by using the decoded reconstructed images of the first group 2n. By referring to FIG. 4, the second codec unit 240′ may receive the intra-frame I1 with respect to the first image 1 and the second image 2 from the second input unit 220, and decode the intra-frame I1 with respect to the first image 1. Thereby, the reconstructed image 1′ is generated corresponding to the first image 1. The second image 2 is inter-encoded by using the reconstructed image 1′ corresponding to the first image 1. Thereby, an inter-frame P2 is generated corresponding to the second image 2.

In explaining an exemplary embodiment with reference to FIGS. 2 to 4, an example of employing two codec units has been explained. However, one will understand that the plurality of codec units may include three codec units, as referenced in FIGS. 5 to 15.

FIG. 5 is a view provided to explain an operation of the plurality of codec units according to a third exemplary embodiment.

Referring to FIG. 5, the plurality of codec units 300 may include input units 310, 320, 330, a first codec unit 340, a second codec unit 350 and a third codec unit 360. The first, second, and third codec units 340, 350, 360 may preferably be implemented in hardware.

The input units 310, 320, 330 may alternately divide the plurality of successively-inputted images into first, second, and third groups, 3n, 3n+1, 3n+2 according to the order of input. In one exemplary embodiment where three codec units are employed, the input units 310, 320, 330 may include the first, second and third input units 310, 320, 330.

The first input unit 310 may provide the first codec unit 340 with the images corresponding to the first group 3n, from among the plurality of images.

The second input unit 320 may provide the second codec unit 350 with the images corresponding to the second group 3n+1, from among the plurality of images.

The third input unit 330 may provide the third codec unit 360 with the images corresponding to the third group 3n+2, from among the plurality of images.

The first codec unit 340 may sequentially intra-encode the respective successive images of the first group 3n. By referring to FIG. 8, the first codec unit 340 may receive the first image 1 from the first input unit 310 and intra-encode the first image 1 to generate encoded image I1 (to be specific, intra-frame) with respect to the first image 1. The image (stream) of the first group 3n encoded at the first codec unit 340 may be stored at the storage unit 130 via the system bus 305 of the electronic apparatus 100.

The first codec unit 340 may decode the encoded images of the first group 3n to generate reconstructed images of the first group 3n, and may directly transfer the generated reconstructed images of the first group 3n to the second and third codec units 350, 360 without using the system bus 305. As explained above, since the reconstructed images are transferred directly to the second and third codec units 350, 360, system bus resources can be saved. However in actual implementation, the generated reconstructed images may also be transferred to the second and third codec units 350, 360 via the system bus 305.

The second codec unit 350 may inter-encode the successive images of the second group 3n+1 by using the respective images which are successively encoded at the first codec unit 340. To be specific, the second codec unit 350 may sequentially inter-encode the respective successive images of the second group 3n+1, by using the respective reconstructed images of the first group 3n directly transferred from the first codec unit 340. By referring to FIG. 8, the second codec unit 350 may receive a reconstructed image 1′ of the first image 1 from the first codec 340, receive the second image 2 from the second input unit 320, and inter-encode the second image 2 by using the reconstructed image 1′ of the first image 1. Thereby, an encoding image P2 is generated (to be specific, inter-frame) corresponding to the second image 2. The image (stream) of the second group 3n+1 encoded at the second codec unit 350 may be stored at the storage unit 130 via the system bus 205 of the electronic apparatus 100.

The second codec unit 350 may decode the encoded images of the second group 3n+1 to generate reconstructed images of the second group 3n+1, and may directly transfer the generated reconstructed images of the second group 3n+1 to the third codec unit 360 without using the system bus 305. To be specific, the second codec unit 350 may decode the encoded images of the second group 3n+1 by using the reconstructed images of the first group 3n which are directly transferred from the first codec unit 340 to generate the reconstructed images of the second group 3n+1. Meanwhile, in actual implementation, the generated reconstructed images of the second group 3n+1 may be transferred to the third codec unit 360 via the system bus 305.

The third codec unit 360 may sequentially inter-encode the respective successive images of the third group 3n+2 by using the respective successively encoded images of the first codec unit 340 and the successively encoded images of the second code units 350. To be specific, the third codec unit 360 may sequentially inter-encode the successive images of the third group 3n+2 input from the third input unit 330 by using the reconstructed images of the first group 3n directly transferred from the first codec unit 340 and the reconstructed images of the second group 3n+1 directly transferred from the second codec unit 350. By referring to FIG. 8, the third codec unit 360 may receive reconstructed image 1′ of the first image 1 from the first codec unit 340, receive the reconstructed image 2′ of the second image 2 from the second codec unit 350, receive the third image 3 from the third input unit 330, and inter-encode the third image 3 by using the reconstructed image 1′ with respect to the first image 1 and the reconstructed image 2′ with respect to the second image 2. Thereby, an encoded image P3 is generated (to be specific, inter-frame) corresponding to the third image 3. At this time, the encoded image (stream) of the third group 3n+2 at the third codec unit 360 may be stored at the storage unit 130 via the system bus 305 of the electronic apparatus 100.

FIG. 6 is a view provided to explain an operation of the plurality of codec units according to a fourth exemplary embodiment.

Unlike the third exemplary embodiment, the second codec unit 350′ does not generate separate reconstructed images in the fourth exemplary embodiment.

Referring to FIG. 6, the plurality of codec units 300′ may include input units 310, 320, 330, a first codec unit 340, a second codec unit 350′, and a third codec unit 360′. In an exemplary embodiment, the first, second and third codec units 340, 350′, 360′ may be implemented as a devoted hardware.

Since the input units 310, 320, 330 operate in the same manner as the input units explained above with reference to FIG. 5, repetitious explanation thereof will be omitted.

Since the first codec unit 340 operate in the almost same manner as the first codec unit of FIG. 5, except that the first codec unit 340 transfer the generated reconstructed images not to the third codec unit 360′, but only to the second codec unit 350′, repetitious explanation thereof will be omitted.

The second codec unit 350′ may sequentially intra-encode the respective successive images of the second group 3n+1, by using the respective successive images which are encoded at the first codec unit 340. To be specific, the second codec unit 350′ may sequentially inter encode the respective successive images of the second group 3n+1 by using the respective reconstructed images of the first group 3n, directly transferred from the first codec unit 340.

The third codec unit 360′ may sequentially inter-encode the respective successive images of the third group 3n+2 by using the respective images successively encoded at the first codec unit 340 and the respective images successively encoded at the second codec unit 350′. To be specific, the third codec unit 360′ may receive the images of the first group 3n encoded at the first codec unit 340, the images of the second group 3n+1 encoded at the second codec unit 350′, and the images of the third group 3n+2 from the third input unit 330. The third codec unit 360′ may then decode the encoded images of the first group 3n to generate reconstructed images of the first group 3n, decode the encoded images of the second group 3n+1 to generate reconstructed images of the second group 3n+1, and inter-encode the respective successive images of the third group 3n+2 by using the generated reconstructed images of the first group 3n and the generated reconstructed images of the second group 3n+1.

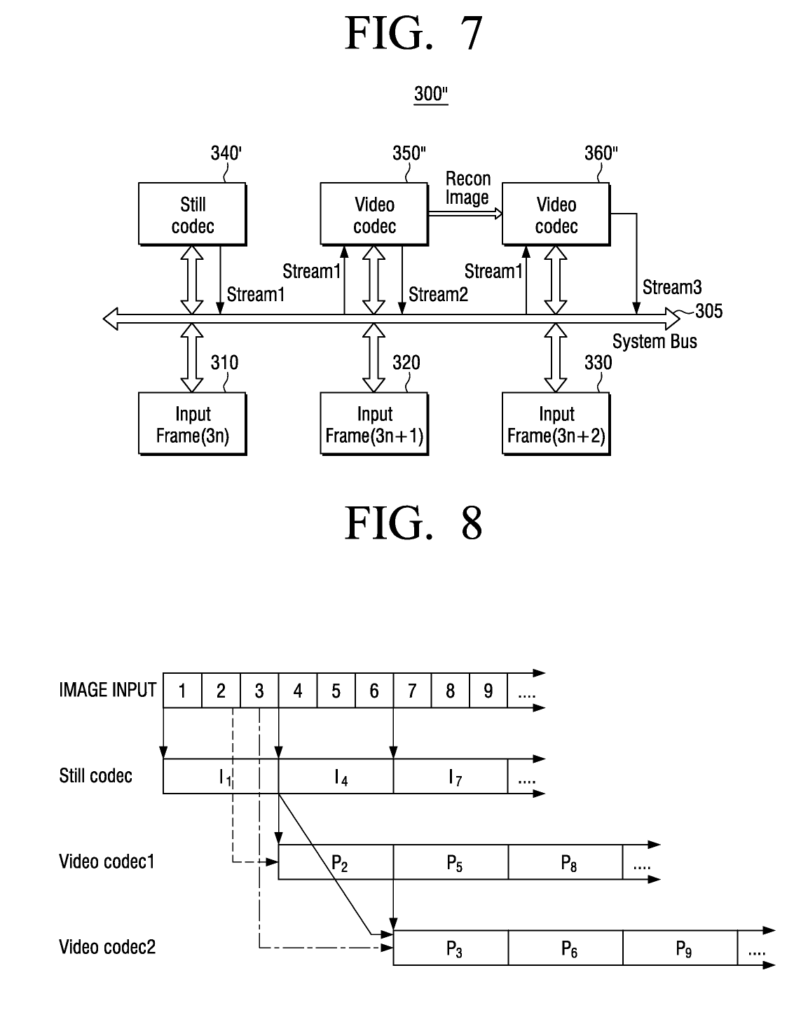

FIG. 7 is a view provided to explain an operation of the plurality of codec units according to a fifth exemplary embodiment.

Unlike the third exemplary embodiment, the first codec unit 340′ according to the fifth exemplary embodiment does not generate separate reconstructed images.

Referring to FIG. 7, the plurality of codec units 300″ may include input units 310, 320, 330, a first codec unit 340′, a second codec unit 350″, and a third codec unit 360″. In an exemplary embodiment, the second and third codec units 350″, 360″ may be implemented as a devoted hardware. The first codec unit 340′ may be implemented as hardware, or alternatively, implemented as software which can operate on a CPU or a DSP.

Since the input units 310, 320, 330 operate in the same manner as the input units explained above with reference to FIG. 5, repetitious explanation thereof will be omitted.

Since the first codec unit 340′ operates in almost the same manner as the first codec unit of FIG. 5, except that the first codec unit 340′ does not generate separate reconstructed images, repetitious explanation thereof will be omitted.

The second codec unit 350″ may sequentially inter-encode the respective successive images of the second group 3n+1, by using the respective images which are successively encoded at the first codec unit 340′. To be specific, the second codec unit 350″ may receive the images of the first group 3n, encoded at the first codec unit 340′, and the images of the second group 3n+1, encoded at the second codec unit 350″, and the images of the third group 3n+2, from the third input unit 330. The second codec unit 350″ may then decode the encoded images of the first group 3n to generate reconstructed images of the first group 3n, decode the encoded images of the second group 3n+1 to generate reconstructed images of the second group 3n+1, and inter-encode the respective successive images of the second group 3n+1, by using the decoded reconstructed images of the first group 3n.

The second codec unit 350″ may decode the encoded images of the second group 3n+1 to generate reconstructed images of the second group 3n+1, and may directly transfer the generated reconstructed images of the second group 3n+1 to the third codec unit 360″ without using the system bus 305. To be specific, the second codec unit 350″ may decode the encoded images of the second group 3n+1 by using the self-generated reconstructed images of the first group 3n, to generate reconstructed images of the second group 3n+2. Meanwhile, in actual implementation, the generated reconstructed images of the second group 3n+1 may be transferred to the third codec unit 360″ via the system bus 305.

The third codec unit 360″ may sequentially inter-encode the respective successive images of the third group 3n+2 by using the images successively encoded at the first codec unit 340′, and the images successively encoded at the second codec unit 350″. To be specific, the third codec unit 360″ may receive the encoded images of the first group 3n from the first codec unit 340′, the reconstructed images of the second group 3n+1 from the second codec unit 350″, and the images of the third group 3n+2, from the third input unit 330. The third codec unit 360″ may decode the images of the first group 3n encoded at the first codec unit 340′ to generate reconstructed images of the first group 3n, and may sequentially inter-encode the respective successive images of the third group 3n+2 by using the respective generated reconstructed images of the first group 3n and transfer reconstructed images of the second group 3n+1.

Although the exemplary embodiments illustrated in FIGS. 5 to 8 illustrate that at least one of the first and second codec units 340, 350 generate the reconstructed images, in actual implementation, both the first and second codec units 340, 350 may not generate the reconstructed images.

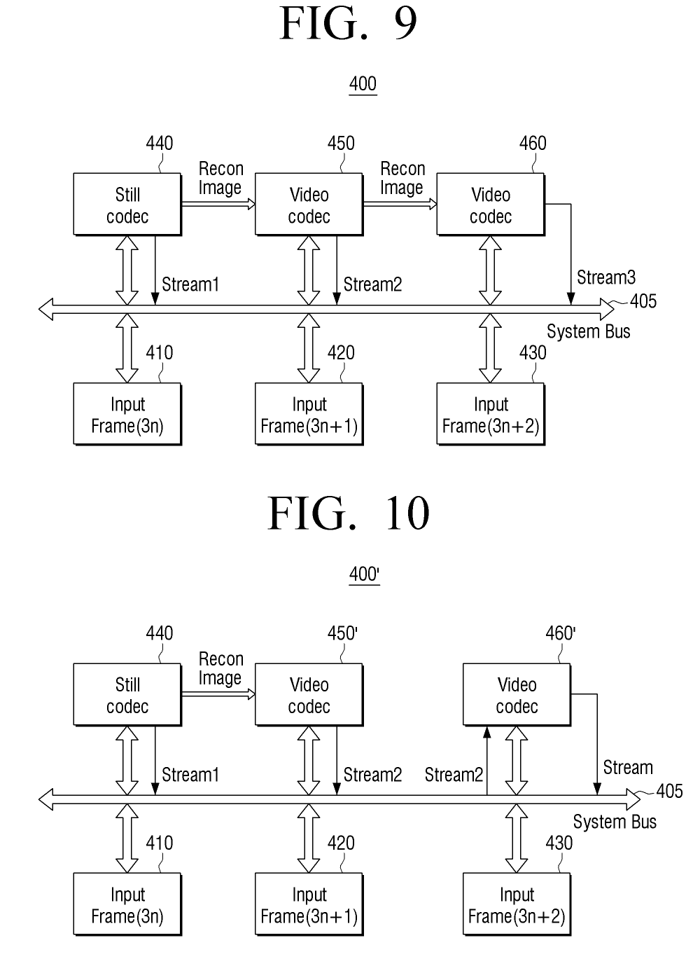

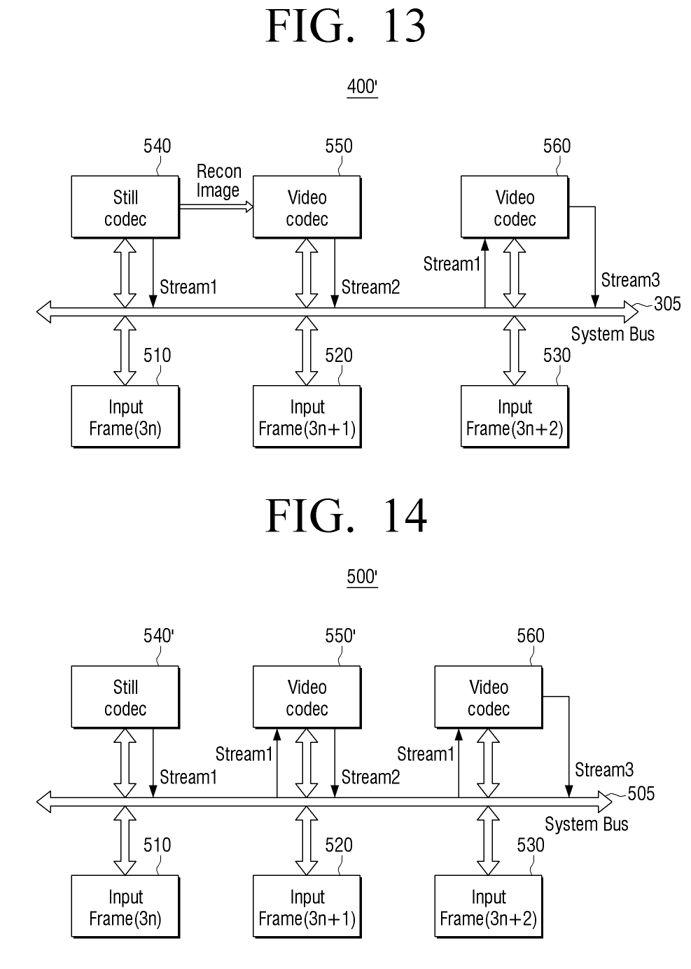

In explaining the exemplary embodiments illustrated in FIGS. 5 to 8, the third codec unit 360 perform the inter-encoding by referring to two images. However, the third codec unit may perform inter-encoding by referring to one image. First, an example where the third codec unit performs inter-encoding by referring only to the encoded images of the second codec unit will be explained with reference to FIGS. 9 to 12. Another example, where the third codec unit performs inter-encoding by referring only to the encoded images of the first codec unit will be explained with reference to FIGS. 13 to 16.

FIG. 9 is a view provided to explain an operation of the plurality of codec units according to a sixth exemplary embodiment.

Referring to FIG. 9, the plurality of codec units 400 may include input units 410, 420, 430, a first codec unit 440, a second codec unit 450 and a third codec unit 460. In an exemplary embodiment, the first, second and third codec units 440, 450, 460 may be implemented in hardware.

Since the input units 410, 420, 430 operate in the same manner as the input units explained above with reference to FIG. 5, repetitious explanation will be omitted.

Since the first codec unit 440 operates in the almost same manner as the first codec unit of FIG. 5, except that the first codec unit 440 does not generate separate reconstructed images, repetitious explanation will be omitted.

Since the second codec unit 450 operates in the same manner as the second codec unit 350 of FIG. 5, repetitious explanation will be omitted.

The third codec unit 460 may sequentially inter-encode the respective successive images of the third group 3n+2 by using the images successively encoded at the second codec unit 450, respectively. To be specific, the third codec unit 460 may receive reconstructed images of the second group 3n+1, from the second codec unit 450, and images of the third group 3n+2, from the third input unit 430, and sequentially inter-encode the respective successive images of the third group 3n+2 using the reconstructed images of the second group 3n+1 directly transferred from the second codec unit 450, respectively. By way of example, referring to FIG. 12, the third codec unit 460 may receive the reconstructed image 2′ of the second image 2 from the second codec unit 450, receive the third image 3 from the third input unit 430, and inter-encode the third image 3 using the reconstructed image 2′ of the second image 2, to generate an encoded image P3 (to be specific, inter-frame) corresponding to the third image 3. At this time, the image (stream) of the third group 3n+2 encoded at the third codec unit 460 may be stored at the storage unit 130 via the system bus 405 of the electronic apparatus 100.

FIG. 10 is a view provided to explain an operation of a plurality of codec units according to a seventh exemplary embodiment.

To be specific, unlike the sixth exemplary embodiment, the second codec unit 450′ does not separately generate reconstructed images in the seventh exemplary embodiment. Compared to the fourth exemplary embodiment, the operations of the rest of the elements, according to the seventh exemplary embodiment, are similar except the third codec unit 460′ performs inter-encoding using only the images of the second group 3n+1, which are encoded at the second codec unit 450′. Therefore, the operation of the third codec unit 460′ will be explained below.

The third codec unit 460′ may sequentially inter-encode the respective successive images of the third group 3n+2 by using the images successively encoded at the second codec unit 450′ respectively. To be specific, the third codec unit 460′ may receive the encoded images of the second group 3n+1, from the second codec unit 450′, and the images of the third group 3n+2, from the third input unit 430. The third codec unit 460′ may then decode the images of the second group 3n+1 encoded at the second codec unit 450′ to generate reconstructed images of the second group 3n+1, and sequentially inter-encode the respective successive images of the third group 3n+2 using the generated reconstructed images of the second group 3n+1 respectively.

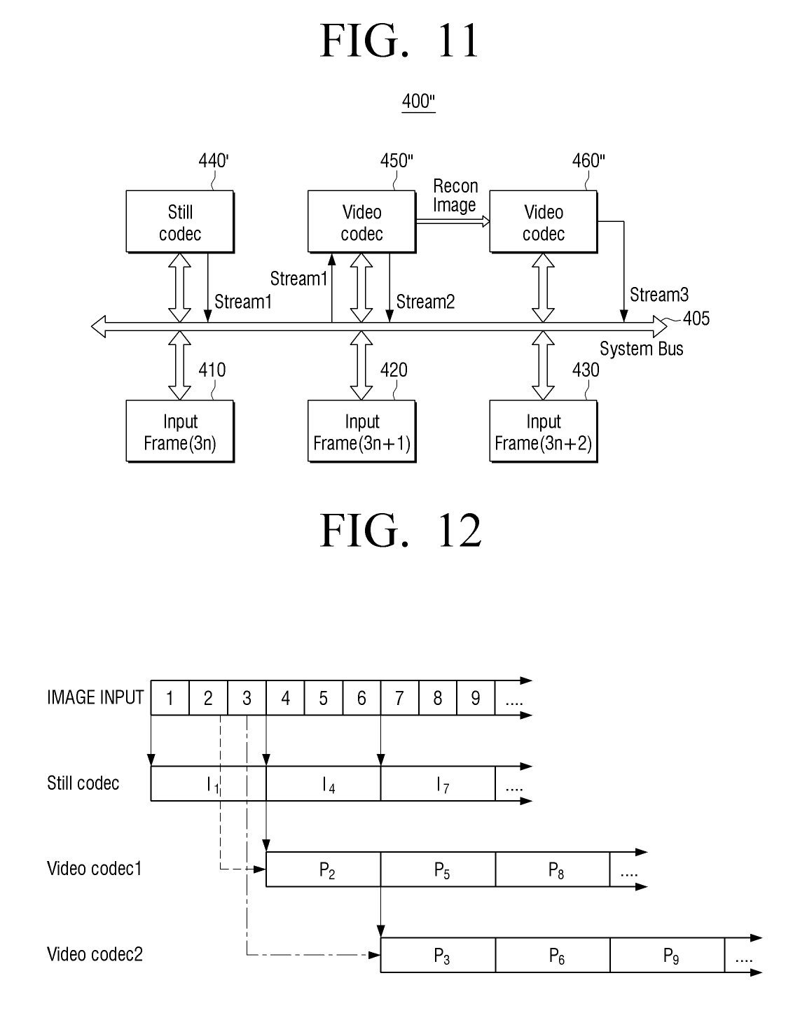

FIG. 11 is a view provided to explain an operation of a plurality of codec units according to an eighth exemplary embodiment.

To be specific, unlike the sixth exemplary embodiment, the first codec unit 440′ does not separately generate reconstructed images in the eighth exemplary embodiment. Compared to the fifth embodiment, the operations of the rest elements according to the eighth embodiment are similar except the third codec unit 460″ performs inter-encoding using only the images of the second group 3n+1, which are encoded at the second codec unit 450″. Therefore, the operation of the third codec unit 460″ will be explained below.

The third codec unit 460″ may sequentially inter-encode the respective successive images of the third group 3n+2 by using the images successively encoded at the second codec unit 450″, respectively. To be specific, the third codec unit 460″ may receive reconstructed images of the second group 3n+1, from the second codec unit 450″, and the images of the third group 3n+2, from the third input unit 460. The third codec unit 460″ may then sequentially inter-encode the inputted images of the third group 3n+2, by using the input reconstructed images of the second group 3n+1, respectively.

FIG. 13 is a view provided to explain an operation of a plurality of codec units according to a ninth exemplary embodiment.

Referring to FIG. 13, the plurality of codec units 500 may include input units 510, 520, 530, a first codec unit 540, a second codec unit 550 and a third codec unit 560. In an exemplary embodiment, the first, second and third codec units 540, 550, 560 may be implemented in hardware.

Compared to the fifth exemplary embodiment, the operations of the rest elements according to the ninth exemplary embodiment are similar except the third codec unit 560 performs inter-encoding using only the images of the first group 3n, which are encoded at the first codec unit 540. Therefore, the operation of the third codec unit 560 will be explained below.

The third codec unit 560 may sequentially inter-encode the respective successive images of the third group 3n+2 by using the images of the first group 3n, which are successively encoded at the first codec unit 540, respectively. To be specific, the third codec unit 560 may receive the encoded images of the first group 3n, from the first codec unit 540, and the images of the third group 3n+2, from the third input unit 530. The third codec unit 560 may then decode the images of the first group 3n, which are encoded at the first codec unit 560, to generate reconstructed images of the first group 3n, and sequentially inter-encode the respective successive images of the third group 3n+2, by using the generated reconstructed images of the first group 3n, respectively.

FIG. 14 is a view provided to explain an operation of a plurality of codec units according to a tenth exemplary embodiment.

To be specific, unlike the ninth exemplary embodiment, the first codec unit 540′ according to the tenth exemplary embodiment, does not separately generate reconstructed images. Since the first codec unit 540′ is identical to the first codec unit 340′ (FIG. 7) and the first codec unit 440′ (FIG. 11), repetitious explanation will be omitted.

Further, since the second codec unit 550′ performs the same functions as the second codec unit 350′ (FIG. 7) and the second codec unit 450″ (FIG. 11), repetitious explanation will also be omitted.

Further, since the third codec unit 550′ performs the same function as the third codec unit 560 (FIG. 13), repetitious explanation will be omitted.

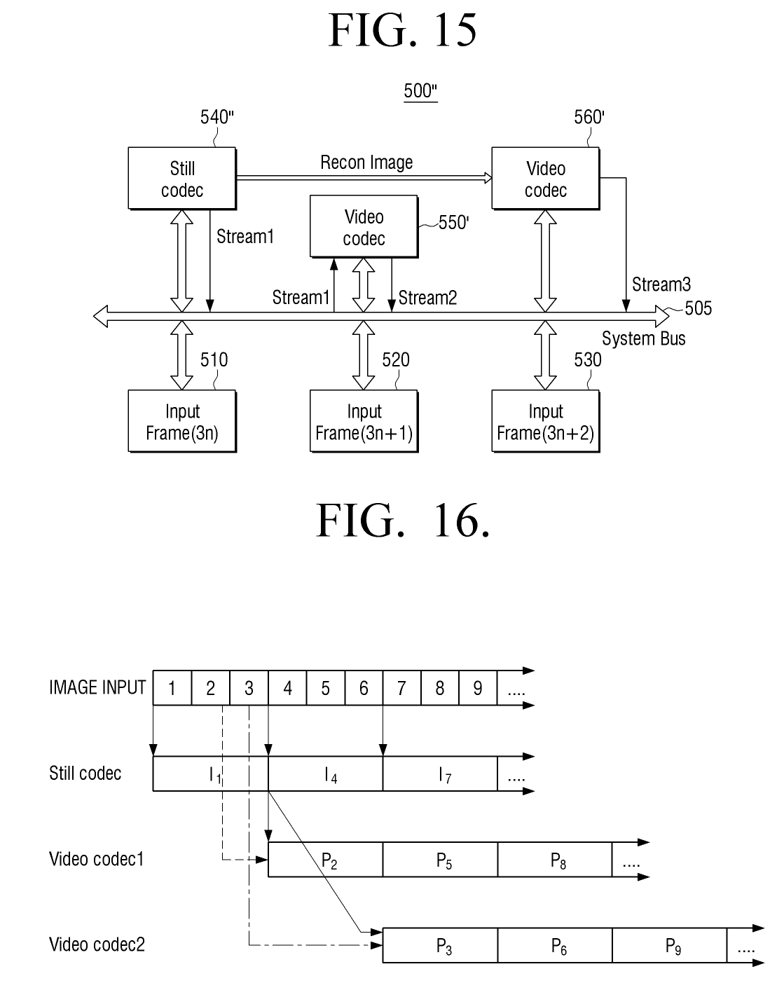

FIG. 15 is a view provided to explain an operation of a plurality of codec units according to an eleventh exemplary embodiment.

To be specific, since the rest operations according to the eleventh exemplary embodiment are similar to those according to the ninth exemplary embodiment, except for the fact that the reconstructed images generated at the first codec unit 540″ are transmitted to the third codec unit 560′ (not the second codec unit 550′), the detailed description about the respective codec units 540″, 550′, 560′ will be omitted for the sake of brevity.

Although the exemplary embodiments employing two or three codec units have been explained so far, four or more codec units may also be employed. Further, although only one of the plurality of codec units performs intra-encoding in the exemplary embodiments illustrated two or more codec units may be implemented to perform intra-encoding. Further, although the inter-encoding generates only P frames, the inter-encoding may generate B frames, or a mixture of P and B frames.

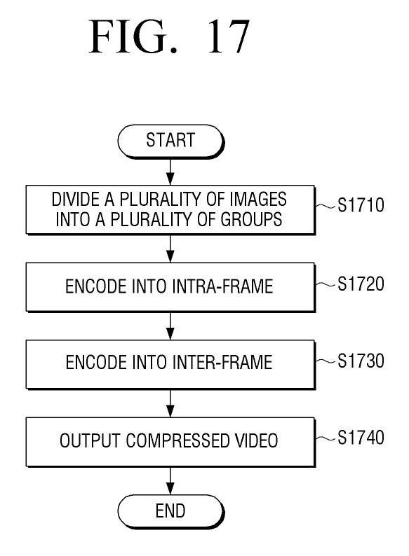

FIG. 17 is a flowchart provided to explain a method for encoding according to an exemplary embodiment.

Referring to FIG. 17, at S1710, a plurality of images is successively input, and at S 1720, the successively-input plurality of images is alternately divided into a plurality of groups. To be specific, the plurality of codec units 200 may divide the plurality of images into a number of groups corresponding to the number of codec units 200 of the electronic apparatus 100. By way of example, there may be two groups of images in the second and the third exemplary embodiment, or three groups according to the fifth to thirteenth exemplary embodiments.

At S1730, the respective successive images of one of the plurality of divided groups may be intra-encoded. The “intra-encode” herein refers to the process of generating frames (e.g., I frames) which can be independently decoded without having to refer to previous or following frames. Intra-encode may be applied as lossless compression, near lossless compression, JPEG, JPEG-XR, H.264 (to be specific, H.264 IDR), or H.265 compression (to be specific, H.265 HEVC).

At S1740, the respective successive images of another group of the plurality of divided groups may be sequentially inter-encoded using the inter-encoded images. For inter-encoding, a variety of conventional compressions of image codec, which refer to previous frames and/or following frames, may be applied. The inter-encoding may be performed in parallel with the intra-encoding in the rest of the frames, except the first frame.

At S1750, a video is generated by combining the intra-encoded and inter-encoded images, and the generated video is stored.

As explained above, since the method for encoding according to an exemplary embodiment encodes a plurality of images, using a plurality of codec units, fast encoding is possible. The method for encoding as illustrated in FIG. 17 may be implemented on an electronic apparatus with the construction as illustrated in FIG. 1, or on other electronic apparatus with different constructions.

Further, the method for encoding may be implemented as at least one execution program to execute the method for encoding, such execution program may be stored on a computer-readable recording media.

Accordingly, the respective blocks according to an exemplary embodiment may be executed as a computer-recordable code on a computer-readable recording media. The computer-readable recording media may be implemented as a device which can store data that can be read by a computer system.

Further, in explaining FIG. 17, although a plurality of codec units perform encoding only, this should not be construed as limiting. In other words, since encoding and decoding are corresponding techniques, an exemplary embodiment may be provided, in which video is decoded in a reverse order of the operation illustrated in FIG. 17.

The foregoing exemplary embodiments and advantages are merely exemplary and are not to be construed as limiting the exemplary embodiments. The present teaching can be readily applied to other types of apparatuses. Also, the description of exemplary embodiments is intended to be illustrative, and not to limit the scope of the claims. Many alternatives, modifications, and variations will be apparent to those skilled in the art.

What is claimed is:

1. An electronic apparatus, comprising:
an inputter, which receives a plurality of successive images, and alternately divides the plurality of successive images into a plurality of divided groups according to an order of input; and
a plurality of codec units, which sequentially intra-encodes the respective successive images of one group, among the plurality of divided groups, and sequentially inter-encodes the respective successive images of another group, among the plurality of divided groups, by using the intra-encoded images.

2. The electronic apparatus of claim 1, wherein the input unit alternately divides the plurality of successive images into a first group and a second group according to the order of input, and
the plurality of codec units comprise:
a first codec unit, which sequentially intra-encodes the respective successive images of the first group; and
a second codec unit, which sequentially inter-encodes the respective successive images of the second group by using the respective successive images encoded at the first codec unit.

3. The electronic apparatus of claim 2, wherein the first codec unit decodes the encoded images of the first group to generate reconstructed images of the first group, and the second codec unit inter-encodes the images of the second group by using the generated reconstructed images of the first group.

4. The electronic apparatus of claim 3, wherein the first codec unit directly transmits the generated reconstructed images of the first group to the second codec unit.

5. The electronic apparatus of claim 2, wherein the second codec unit decodes the images encoded at the first codec unit to generate reconstructed images of the first group, and inter-encodes the images of the second group by using the generated reconstructed images of the first group.

6. The electronic apparatus of claim 1, wherein the input unit divides the plurality of successive images into a first group, a second group, and a third group according to the order of input, and
the plurality of codec units comprise:
a first codec unit, which sequentially intra-encodes the respective successive images of the first group,
a second codec unit, which sequentially inter-encodes the respective successive images of the second group by using the respective images successively encoded at the first codec unit, and
a third codec unit, which inter-encodes the respective successive images of the third group by using at least one encoded image of the images of the first group, encoded at the first codec unit, and the images of the second group, encoded at the second codec unit.

7. The electronic apparatus of claim 6, wherein the first codec unit decodes the encoded images of the first group to generate reconstructed images of the first group.

8. The electronic apparatus of claim 7 wherein the second codec unit inter-encodes the images of the second group by using the generated reconstructed images of the first group.

9. The electronic apparatus of claim 7, wherein the third codec unit inter-encodes the images of the third group by using the generated reconstructed images of the first group.

10. The electronic apparatus of claim 6, wherein the second codec unit decodes the encoded images of the second group to generate reconstructed images of the second group.

11. The electronic apparatus of claim 10, wherein the third codec unit inter-encodes the images of the third group by using the generated reconstructed images of the second group.

12. The electronic apparatus of claim 7, wherein the first codec unit directly transmits the generated reconstructed images of the first group to at least one of the second codec unit and the third codec unit.

13. The electronic apparatus of claim 6, wherein the second codec unit decodes the encoded images at the first codec unit to generate reconstructed images of the first group, and inter-encodes the images of the second group by using the generated reconstructed images of the first group.

14. The electronic apparatus of claim 6, wherein the third codec unit decodes at least one of the encoded images of the first group, encoded at the first codec unit and the encoded images of the second group, encoded at the second codec unit, to generate at least one reconstructed image, and inter-encodes the images of the third group by using the generated at least one reconstructed image.

15. The electronic apparatus of claim 1, wherein the plurality of codec units operate in parallel.

16. The electronic apparatus of claim 1, wherein the intra-encoding comprises at least one compression type of lossless compression, near lossless compression, JPEG, JPEG-XR, H.264, and H.265 compressions.

17. A method for encoding an electronic apparatus having a plurality of codec units, the method comprising:
receiving a plurality of successive images;
alternately dividing the plurality of successive images into a plurality of divided groups according to an order of input;
sequentially intra-encoding, using at least one of the plurality of codec units, the respective successive images of one group, among the plurality of divided groups; and
sequentially inter-encoding, using another codec unit of the plurality of codec units, the respective successive images of another group, among the plurality of divided groups, by using the intra-encoded images.

18. The method for encoding of claim 17, further comprising:
decoding the intra-encoded images to generate reconstructed images,
wherein the inter-encoding comprises inter-encoding the images of the another group by using the generated reconstructed images.

19. The method for encoding of claim 17, wherein the intra-encoding and the inter-encoding are performed in parallel.

20. The method for encoding of claim 17, wherein the intra-encoding comprises at least one compression method of lossless compression, near lossless compression, JPEG, JPEG-XR, H.264, and H.265 compressions.
